(19) United States
(12) Patent Application Publication
(10) Pub. No.: US 2008/0082433 A1
(43) Pub. Date: Apr. 3, 2008

(54) Online information marketplace

(76) Inventors: Daniel Jason Hodges, Santa Clara, CA (US); Donald Louis Hodges, Walnut Creek, CA (US); Yusaku Sako, Fremont, CA (US)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 11/490,788

(22) Filed: Jul. 21, 2006

(51) Int. Cl. G07F 19/00

(52) U.S. Cl. 705/34

(57) ABSTRACT

An online information marketplace allows users to buy and sell information, such as contact information. Information received from one or more information sources are provided to users. The received information may include information entered via freeform data entry. A subset of the information is provided to a user. The information sources who provided the information that was provided to the user is awarded compensation. The amount of compensation may be based on the number of information sources who provided the information, which information source provided the information first, and/or the order in which the information sources provided the information.

### TECHNICAL FIELD

The disclosed embodiments relate generally to online services, and more particularly, to an online marketplace for buying and selling information.

### BACKGROUND

Contact information is important to today's businesses. Contact information may be used for various business initiatives, such as marketing to potential customers, recruiting personnel, or sourcing new business opportunities, clients, or suppliers. Contact information may be used with various marketing techniques, such as targeted marketing and telemarketing, in order to further these business initiatives. As a result, businesses often expend many resources to acquire contact information.

Currently, contact information may come in the form of contact lists purchased from firms that compile such lists. However, these contacts lists have some shortcomings. One is that they may be incomplete; contact lists often do not include persons of influence or decision-making authority that are not in senior management. Also, contact lists can be quite expensive. Furthermore, contact lists often do not leverage the redundant information available throughout the world as a way to verify the information in the lists. These shortcomings have made contact lists less effective.

Accordingly, there is a need for more efficient ways to acquire contact information.

### SUMMARY

According to some embodiments, a computer-implemented method of acquiring information includes receiving information from one or more information sources, providing at least a subset of the information to a user, and awarding compensation to one or more respective information sources that provided information included in said subset of the information provided to the user.

According to some embodiments, a computer system includes memory, one or more processors, and one or more modules stored in the memory and configured for execution by the one or more processors. The one or more modules includes instructions to receive information from one or more information sources, instructions to provide at least a subset of the information to a user, and instructions to award compensation to one or more respective information sources that provided information included in said subset of the information provided to the user.

According to some embodiments, a computer program product for use in conjunction with a computer system includes a computer readable storage medium and a computer program mechanism embedded therein. The computer program mechanism includes instructions for receiving information from one or more information sources, instructions for providing at least a subset of the information to a user, and instructions for awarding compensation to one or more respective information sources that provided information included in said subset of the information provided to the user.

According to some embodiments, a system includes means for receiving information from one or more information sources, means for providing at least a subset of the information to a user, and means for awarding compensation to one or more respective information sources that provided information included in said subset of the information provided to the user.

### BRIEF DESCRIPTION OF THE DRAWINGS

For a better understanding of the aforementioned embodiments, as well as additional embodiments thereof, reference should be made to the Description of Embodiments below, in conjunction with the following drawings in which like reference numerals refer to corresponding parts throughout the figures.

FIG. 1 is a conceptual diagram illustrating transactions between information sources and users via an online information marketplace in accordance with some embodiments.

FIG. 2 is a block diagram illustrating a computer network in accordance with some embodiments.

FIG. 3 is a flow diagram illustrating a process of buying and selling information in accordance with some embodiments.

FIGS. 4A-4C is a flow diagram illustrating an exemplary user flow in a session in an online information marketplace in accordance with some embodiments.

FIG. 5 is a flow diagram illustrating a process of providing information to an online information marketplace in accordance with some embodiments.

FIG. 6 illustrates an exemplary interface for providing information to an online information marketplace in accordance with some embodiments.

FIG. 7 illustrates an exemplary interface for adding a custom information field in accordance with some embodiments.

FIG. 8 illustrates a table listing exemplary amounts of compensation to one or more information providers in accordance with some embodiments.

FIG. 9 illustrates an exemplary interface for editing templates in accordance with some embodiments.

FIG. 10 is a block diagram illustrating an information system in accordance with some embodiments.

FIG. 11 is a block diagram illustrating a client in accordance with some embodiments.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, etc. have not been described in detail so as not to unnecessarily obscure aspects of the embodiments.

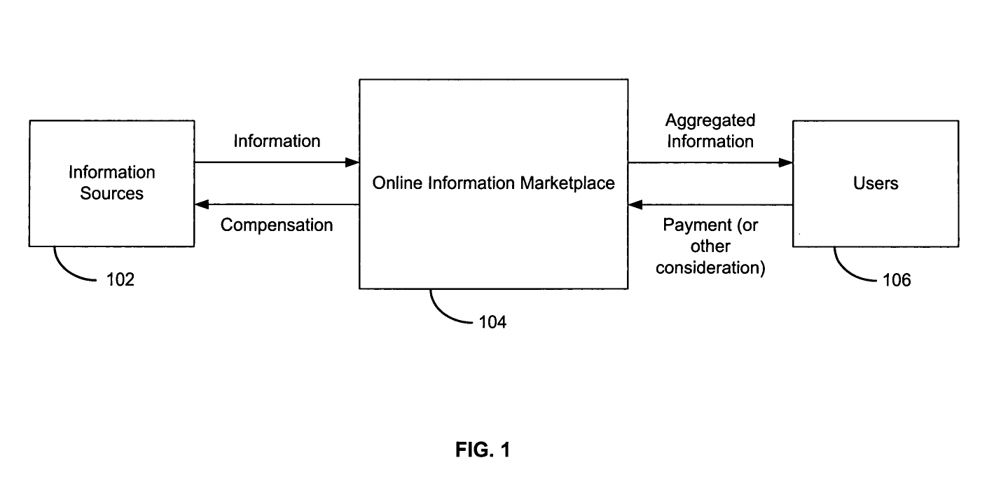

Attention is directed to FIG. 1, which illustrates transactions between information sources and users via an online information marketplace in accordance with some embodiments. As used herein, a “user” refers to anyone that has authorized access to the online information marketplace. In some embodiments, a user is registered with the online information marketplace and has an account with the online information marketplace. In these embodiments, an “information source” refers to a user who has provided and/or is providing information to the online information marketplace so that the information may be purchased by users. Thus, in these embodiments, all information sources are also users, and a user can become an information source by providing information to the online information marketplace.

One or more information sources 102 provide information to an online information marketplace 104. The online information marketplace 104 collects the information from the information sources 102. The online information marketplace 104 may also collect information using automated processes, such as crawling web sites or databases for information, in addition to receiving information from information sources. In some embodiments, the online information marketplace 104 also aggregates and analyzes the collected information. The online information marketplace 104 may provide at least a portion of the information collected by the online information marketplace to one or more users 106 in exchange for payment or other consideration from the users 106; the one or more users 106 purchase information from the online information marketplace 104. Whenever a user has purchased information from the online information marketplace 104, compensation is awarded to the information sources that provided the particular information purchased by the user. The amount of compensation awarded to an information source may be based on the total number of information sources who provided the purchased information. The amount of compensation may be further based on which information source was the first to provide the purchased information, or even the order in which the information sources provided the purchased information.

In other words, the online information marketplace 104 provides a platform where users can buy and sell information. Information sources may provide information for sale to the online information marketplace, where the provided information may be sold to users. The provided information may be purchased by other users, and the information sources or sources that provided the purchased information are awarded compensation. In some embodiments, an information source may provide information to the online information marketplace anonymously with respect to other users; the online information marketplace does not reveal to other users the person(s) who provided a particular item of information. Also, in some embodiments, a user may search for or purchase information anonymously with respect to information sources; the online information marketplace does not reveal to an information source the searcher or purchaser of an item of information.

In some embodiments, information that may be exchanged via the online information marketplace 104 includes contact information. Contact information may include information associated with one or more persons, such as first and last name, address, geographical region, phone number (which may include numbers for fax, mobile phone, or pager), email address, occupation, job title, job function, company name, industry, and so forth. Contact information may further include supervisors, subordinates, web page, interests (business or personal), memberships, education, personal preferences, prior employment, and so forth. It should be appreciated, however, that the information that may be included in contact information, described above, are merely exemplary. Contact information may include other information in addition to the information categories listed above.

For ease of understanding, the information described in the embodiments disclosed below is contact information. However, it should be appreciated that the disclosed embodiments may be adapted to for other types of information.

It should be appreciated that while the description above describes the users as buying information in exchange for (monetary or credit) payment, other forms of consideration may be used. For example, in some embodiments, users may acquire information in exchange for viewing one or more advertisements. In some other embodiments, a user may acquire information if he provides new information to the online information marketplace; the user trades information for information.

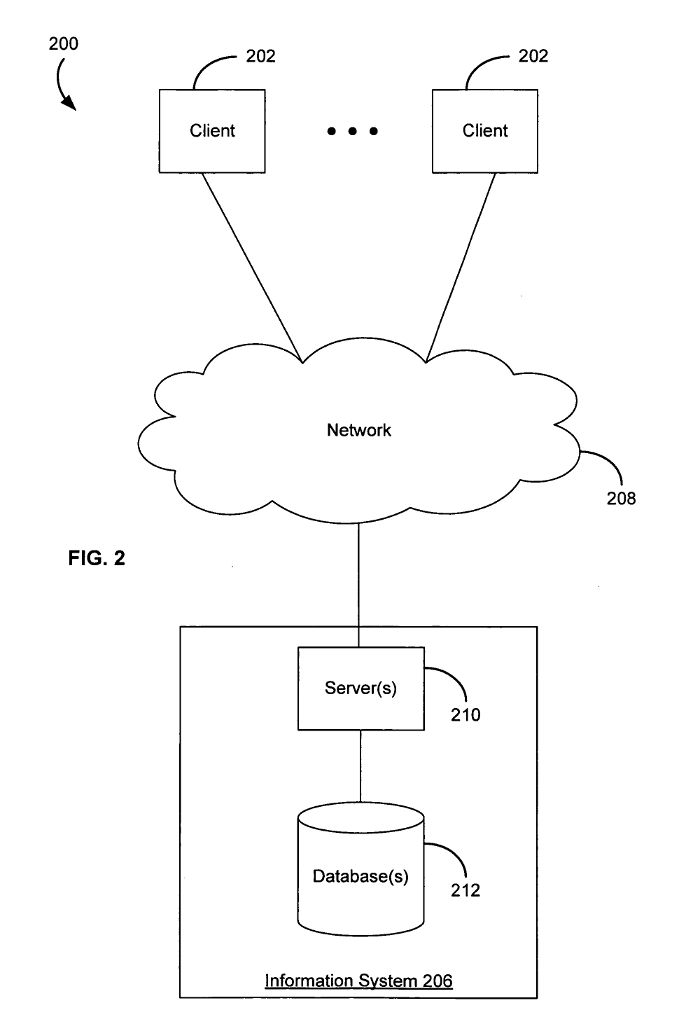

Attention is now directed to FIG. 2, which is a block diagram illustrating a computer network in accordance with some embodiments. The computer network 200 includes one or more clients 202, an information system 206, and a network 208 that interconnects these components. The network 208 may include any of a variety of communicative networks, such as local-area networks (LAN), wide-area networks (WAN), wireless networks, and the Internet.

The clients 202 are devices from which a user may access the information system 206 to buy and/or to provide contact information. The client 202 may be any device capable of communicating with other computers, devices, and so forth, including the information system 206, through the network 208. Examples of client devices may include, without limitation, desktop computers, notebook (or laptop) computers, personal digital assistants (PDAs), mobile phones, network terminals, and so forth. In some embodiments, the client device 202 includes one or more applications for communicating with other computers or devices through the network 208. One example of an application is a web browser.

The information system 206 of an online information marketplace provides a platform where users may buy or sell contact information. The information system 206 may include one or more servers 210 and one or more databases 212. The server(s) 210 provides a front end interface with which users interact to access the information system 206. In some embodiments, the server(s) 210 provides a Web-based interface comprising pages written in the Hypertext Markup Language (HTML) and other languages suitable for authoring web pages. The web-based interface may be accessed via a web browser. The contact information provided by users, as well as other information, may be stored in a database(s) 212. The database(s) 212 may be implemented using any of a plurality of database models that are currently known or later developed, such as a relational model or an object database model.

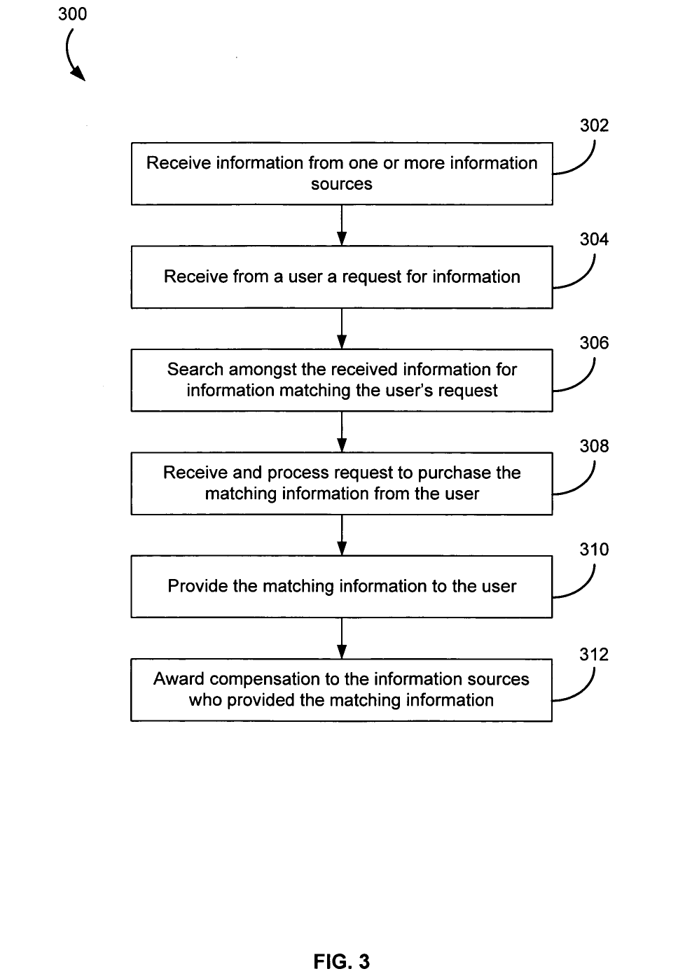

Attention is now directed to FIG. 3, which is a flow diagram illustrating a process flow 300 of buying and selling information in an online information marketplace in accordance with some embodiments. Contact information is received from one or more information sources (302). The received contact information may include contact information associated with one or more persons (“contacts”). The received contact information may include redundant information, i.e. information that repeats information that has been provided before and already stored in the online information marketplace.

The received contact information may be stored in the online information marketplace. In some embodiments, the contact information stored in the database 212 is also aggregated and analyzed to resolve redundancies and inconsistencies, to identify connections or relationships between contacts, and/or to verify the contact information. This may include consolidating redundant information and resolving inconsistencies in accordance with one or more predefined rules.

In some embodiments, the contact information is received in the form of one or more attribute-value pairs. An attribute (or a field) is identified by a field name and has a corresponding data type. Examples of data types include text (length-limited or not), number (e.g., integer, float), number range, name, address, date, date range, multiple choice, and so forth. In some embodiments, a predefined set of one or more default fields are provided by the online information marketplace.

The online information marketplace may also allow the creation of custom, user-defined fields, further details of which are described below. A user may define a user-defined field by providing a field name and a data type for the attribute. Once a user-defined field is created, it is saved in the information system and may be adopted by other users.

A request for contact information is received from a user (304). Whenever a user wishes to acquire contact information, the user may make a request to the online information marketplace. In some embodiments, the request is a search query for contact information in the database that satisfies one or more parameters specified in the query. The information stored in the database 212 is searched for contacts that satisfy the query (306). The result of the search, or a summary or preview thereof is presented to the user. In some embodiments, the results are presented as a number of unique contacts that satisfy all of the parameters in the query.

The user may purchase the contact information found in the search. The user places a request to purchase the information. The purchase request, which may include a method of payment, is received and processed (308). After the request is processed, the purchased contact information is presented to the user (310). In some embodiments, the contact information is not presented to the user until the payment has been made, electronically or otherwise. The contact information shown to the user may include names, phone numbers, physical addresses, and email addresses. In some embodiments, the user may choose which of the above are shown (names, phone numbers, etc.).

In some embodiments, the value or the purchase price of the contact information to be paid by the user may vary based on the focus of the search query that yielded the contact information to be purchased. For example, if a first search searched for CEO's and a second search searched for CEO's who play golf, the per item or per unit purchase price of the information from the second search is higher because the second search is more focused. In other words, search results from more focused or narrow searches are more valuable.

The information sources that provided the purchased information are awarded compensation (312). In some embodiments, the compensation may include money paid to the information sources via electronic payment or transfer. In some other embodiments, compensation may include credits that may be applied toward purchases of contact or other information from the information system, or other non-monetary compensation. In some embodiments, the amount of compensation that is awarded for a particular item of contact information (e.g., an attribute-value pair associated with a contact) may be based on the number of information sources who provided the particular item, the completeness or accuracy of the provided item of information, which information source provided the particular item first, and/or the order in which the information sources provided the information.

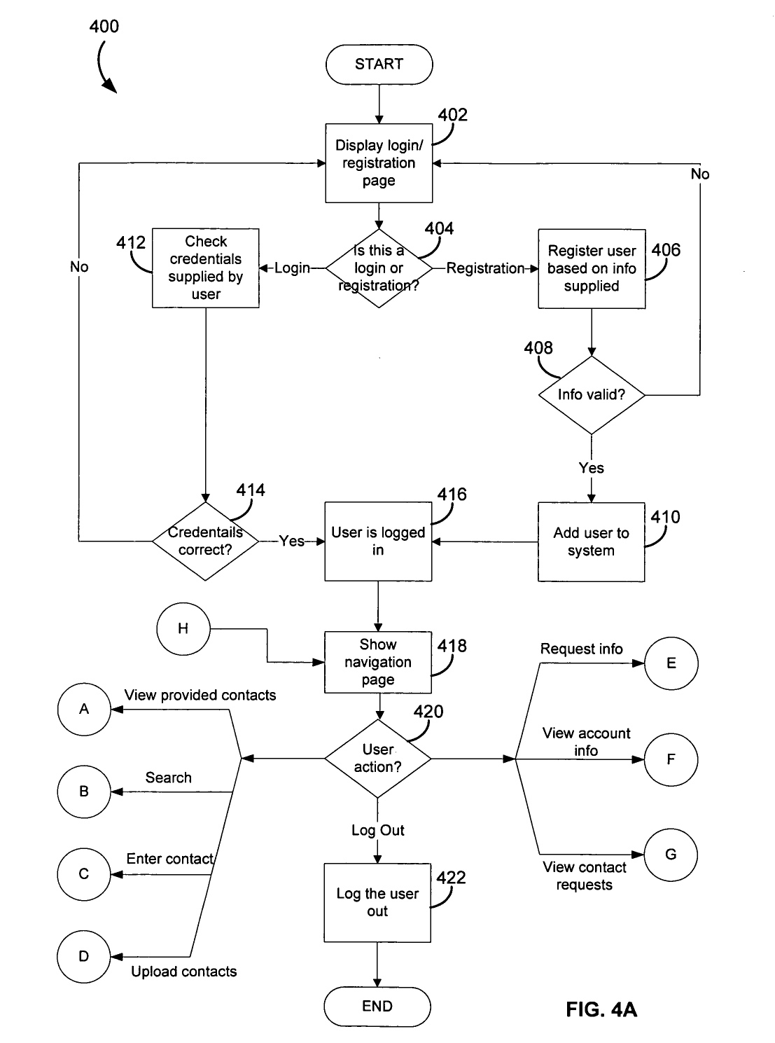

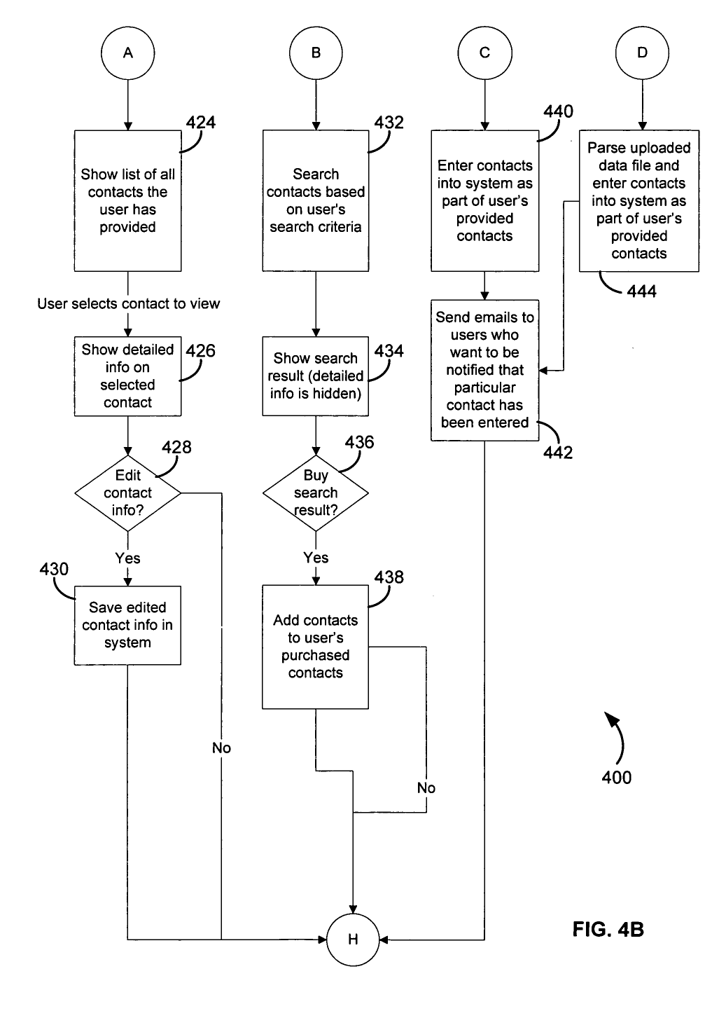

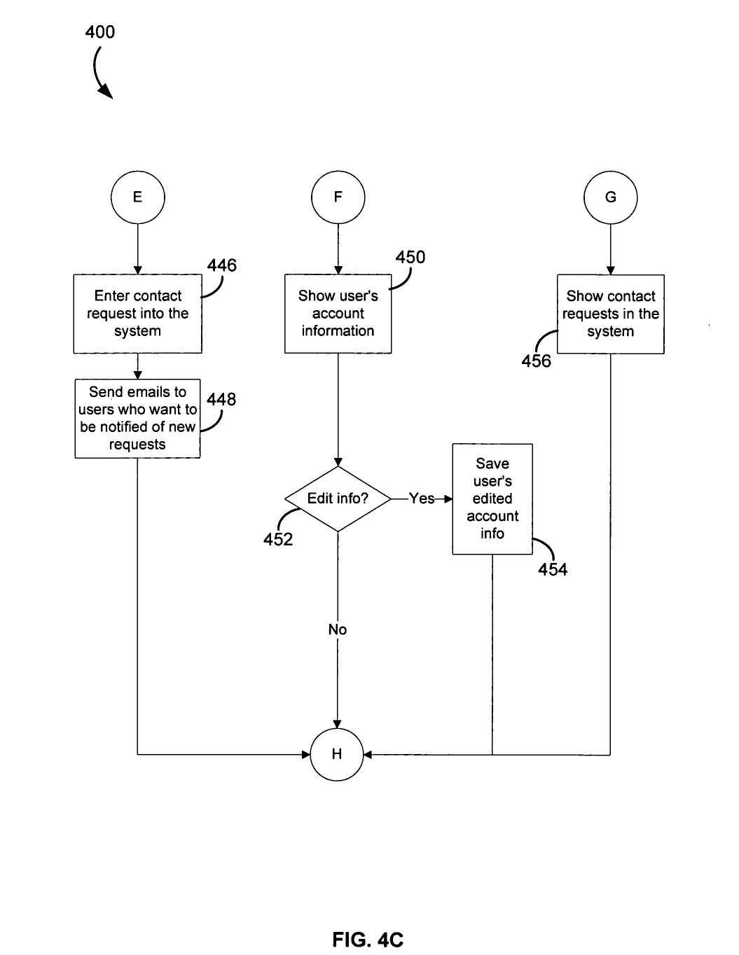

Attention is now directed to FIGS. 4A-4C, which is a flow diagram illustrating an exemplary user flow 400 in a session in an online information marketplace in accordance with some embodiments. In some embodiments, a user may access the online information marketplace via a web browser. For example, the user may type in a Universal Resource Locator (URL) of the online information marketplace into the web browser. A login/registration page of the online marketplace is displayed (402). In some embodiments, the login/registration page is displayed as the home page of the online information marketplace. In some other embodiments, at the start, a home page of the online information marketplace is first displayed to the user and then the user may navigate from the home page to a login or registration page. From the login/registration page, a first time user of the marketplace may register with the marketplace and set up an account. Registered users may log in from the login/registration page. In some embodiments, the login/registration page may also provide for retrieval of a forgotten username and/or password. Additionally, in some embodiments, the login page and the registration page may be distinct pages. Furthermore, in some other embodiments, the online information marketplace may offer a limited service to unregistered users, where the unregistered users may be allowed to perform a limited search (e.g., search only on particular fields) and view the matching contacts, which may be limited to a predetermined number, for free.

If the user is attempting to register with the online marketplace (404—Registration), the user may be asked to supply pertinent registration information such as username, password, name, and email address. The user may be further asked to supply other information, such as a mailing address, taxpayer identification number, and so forth. In some embodiments, the email address is also used as the username. The marketplace attempts to register the user based on the information supplied by the user (406). If the information is valid (408—Yes), the user is added to the system (410). The user is also logged in (416) and may begin using the online information marketplace. If the information is invalid (408—No), the registration is rejected and the user is taken back to the login/registration page (402), where the user may restart the registration process. In some embodiments, instead of taking the user back to the login/registration page after a rejected registration, the user is notified that one or more items of information supplied for the registration process are invalid and is asked to correct the invalid items of information. In some embodiments, reasons for invalidity include, among others, the supplied username being already taken by another user or the password not satisfying specified criteria (e.g., a minimum length, a requirement to include both letters and numbers).

From the login/registration page, If the user is attempting to log in (404—Login), the user is asked to supply login credentials, such as a username and password. The credentials supplied by the user are checked (412). If the credentials check out (414—Yes), the user is logged in (416) and may begin using the online information marketplace. If the credentials do not check out (414—No), the user is taken back to the login/registration page (402) and the user is asked to supply the correct credentials.

After the user is logged in, a navigation page is displayed to the user (418). In some embodiments, the navigation page is one of one or more pages that make up the interface of the online information marketplace. The navigation page may be a page from which the user may access other pages and perform various actions in the online information marketplace. The interface may include links, forms, and so forth for performing any of several actions. In some embodiments, the user actions include viewing the contact information that has been provided to the marketplace by the user, searching for and buying contact information, providing contact information by manual entry or file upload, making a request for contact information satisfying specified parameters, viewing outstanding requests for contact information satisfying specified parameters, viewing account information, or logging out from the marketplace.

If the user action is viewing the contact information that were provided to the online information marketplace by the user (420—View provided contacts), a list of contacts the user has provided to the online information marketplace is displayed to the user (424). The user may select a particular contact from the list, in order to view the information for the selected contact. In response to the selection, the detailed information for the selected contact is displayed (426). From here, the user may edit the detailed information for the selected contact. If the user did edit the information (428—Yes), the edited information is saved (430). The user may then be taken back to the navigation page (418). If the user did not edit the information (428—No), the user may be taken back to the navigation page (418).

From the navigation page, the user may perform a query for contact information in the marketplace. The navigation page may provide one or more search boxes, with which the user may query for contacts. In some embodiments, the navigation page may include search boxes corresponding to particular fields, where the user may enter search terms in order to search on particular fields. In some other embodiments, the user navigates from the navigation page to a search page showing one or more fields for which the user may enter search parameters. If the user action is searching for contacts (420—Search), the contacts in the marketplace are searched based on the query entered by the user (432). After the search is complete, the search results are displayed to the user (434). In some embodiments, the search results only show the number of contacts that match the query parameters, keeping the actual contact information hidden until the user purchases the information. In some other embodiments, the search results show only a preview of the contacts that match the query, such as only a limited number of fields (for example, names but not phone numbers or addresses) or complete data for only one or a few of the matching contacts. From the search results display, the user may proceed to buy the contact information that matches the query parameters. If the user buys the matching contact information (436—Yes), the matching contact information is added to the set of contact information that has been purchased by the user (438). The user may then be taken back to the navigation page (418). If the user does not buy the contacts (436—No), the user may be taken back to the navigation page (418). In some embodiments, the user may also save the search queries for future use. More generally, in some embodiments, a user may create one or more search templates and share the search templates with other users. A search template specifies the fields that may be shown in the search page or what search boxes may be shown in the navigation page.

The user may provide contact information to the marketplace by manual entry or by file upload. The navigation page may include a page where the user may enter contact information, which includes values associated with one or more contacts. Also, the navigation page may accept contact information in file formats such as a comma-separated values file (.csv), vCard file (.vcf), and so forth. If the user action is entering contact information manually (420—Enter contact), the entered contact information is stored in the online information marketplace as part of the user's set of provided contacts (440). In some embodiments, a notification may be sent to other users who want to be notified when particular contacts have been entered, if those particular contacts were entered and stored in block 440 (442). Similarly, if the user uploads contacts to the online information marketplace in a file (444), the file is parsed and the contact information included within is stored into the marketplace as part of the user's set of provided contacts (440). A notification may then be sent to other users who want to be notified when particular contacts have been entered, if those particular contacts were entered and stored in block 444 (442). After the notification, the user may be taken back to the navigation page (418). It should be appreciated that, in some embodiments, contact information may be gathered for storage in the online information marketplace via automated processes, such as a web crawler or a direct link to a database.

A user may also make a request for contacts that satisfy specified criteria, rather than merely search for whatever contacts are already available in the online information marketplace. That is, the user may make a solicitation of sorts for contacts matching specified characteristics. If the user action is making such a request (420—Request contact info), the request is entered into the system (446). Users who wish to be notified of new requests may be notified (448). In some embodiments, the notification is by email. In some other embodiments, the notification is provided the next time the user who wishes to be notified logs into the online information marketplace. The notification allows users to stay abreast of new requests for contact information, to which they can respond by providing contact information that satisfies the requests. After a request, the user may be taken back to the navigation page (418).

A user may view information associated with his account in the marketplace 420—View account info). The user's account information is shown to the user (450). If the user edits the account information (452—Yes), the edited account information is stored in the online information marketplace (454). If the user does not choose to edit his account information (452—No), or after the user is finished edit his account information, the user may be taken back to the navigation page (418).

A user may view outstanding requests or solicitations for contacts that satisfy specified criteria (420—View Contact Requests). Outstanding contact requests are presented to the user (456). The user may also add to or comment on an outstanding request. Afterwards, the user may be taken back to the navigation page (418).

When the user is finished, the user may log out (420—Log Out). The user is logged out (422), completing the session. If the user wishes to reenter the online marketplace, the user may navigate to the login page (402) and log in.

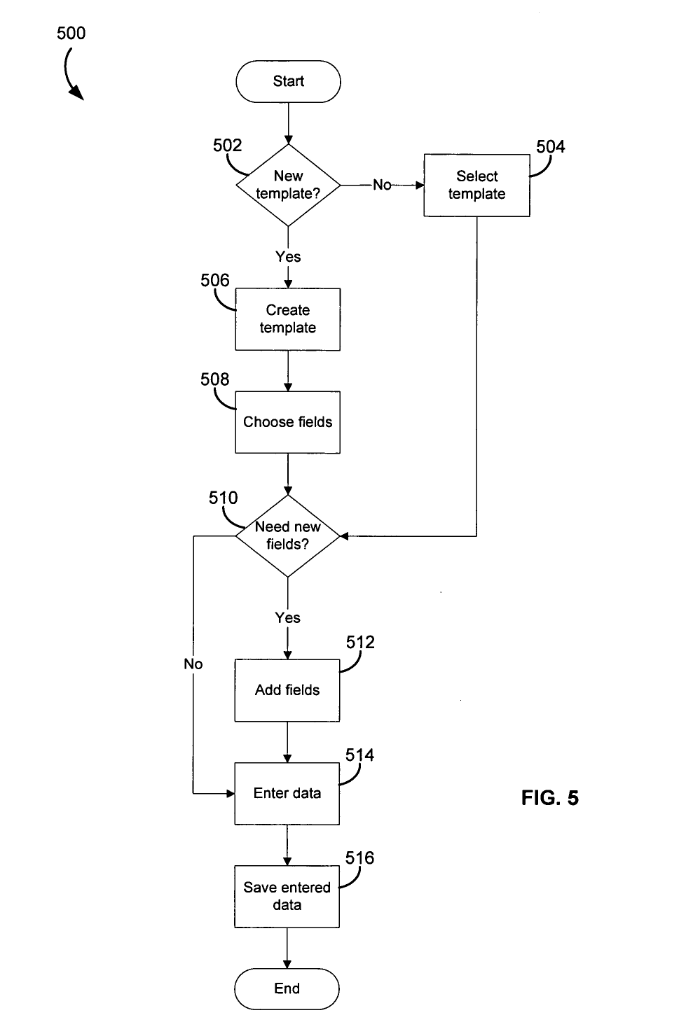

Attention is now directed to FIG. 5, which illustrates a process flow 500 for providing information to an online information marketplace in accordance with some embodiments. When the user wishes to provide information associated with a contact, the user may enter values for one or more mandatory fields and any number of other fields. In some embodiments, the user may specify which fields are shown in the data entry form via templates. Each template specifies the fields that are shown to the user at the information entry page.

When the user wishes to enter contact information into the marketplace, the user may be asked if he wishes to create a new template or use an existing template. If the user wishes to use a new template (502—Yes), the user creates a new template (506) and chooses the fields for that template (508). If the user wishes to use an existing template (502—No), the user may select an existing template (504).

Whether the user creates a new template or uses an existing template, the user may need additional fields not already in the template. If the user needs additional fields (510—Yes), the user may add one or more additional fields (512). In some embodiments, the user may also remove one or more fields. After additional fields are added, or if the user does not wish to add additional fields (510—No), the user proceeds to enter values for the fields (514). When the user is finished and submits the values, the entered values are saved (516).

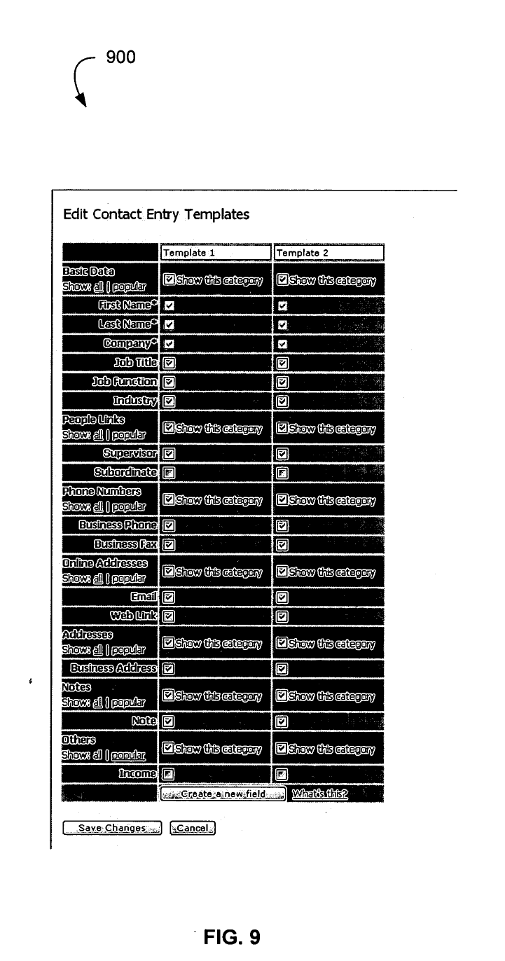

The user may also edit a template by navigating, for example, to a template editing form 900 (FIG. 9). A template editing form allows the user to enter a name for a template, select categories of fields and individual fields for inclusion in the template, and add or create fields for a template.

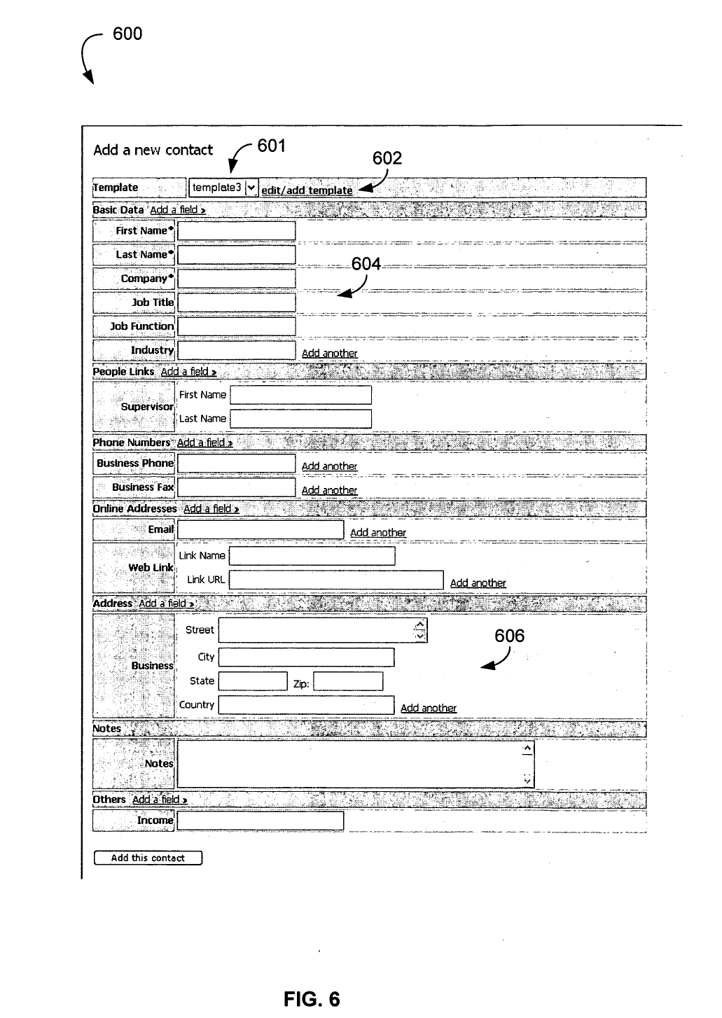

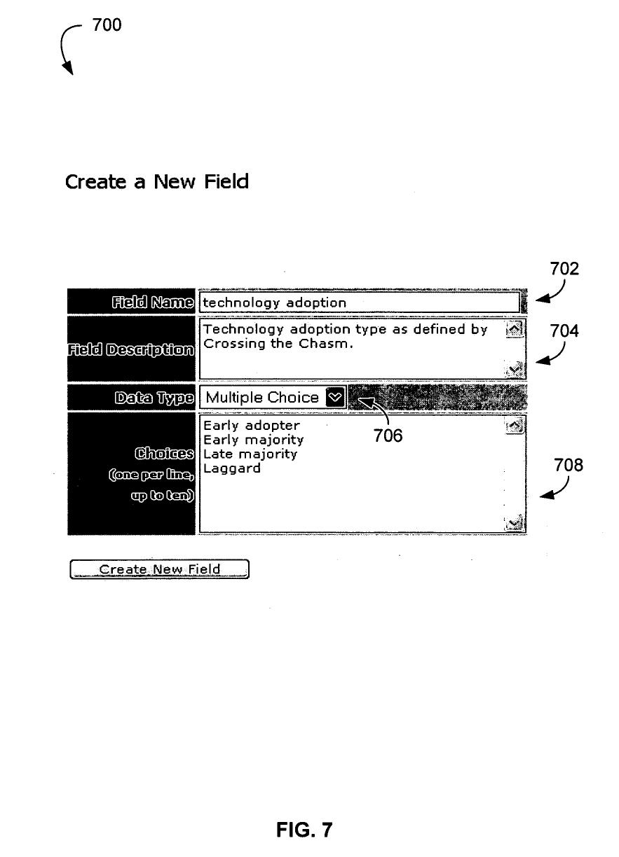

Attention is now directed to FIGS. 6-7, which illustrate exemplary interfaces for providing information associated with a contact to the marketplace in accordance with some embodiments. In some embodiments, the interface for providing contact information in the online information marketplace includes a form 600 in a web page. The contact information entry form 600 may include a menu 601 for selecting an existing template and a link 602 for navigating to a page where templates may be added or modified.

The contact information entry form 600 also includes text boxes 604 for one or more fields. The user may enter a value for a field in the text box corresponding to that field. The entry form includes both fields provided by the online information marketplace and custom, user-defined fields adopted by the user. In some embodiments, a field may have sub-fields. For example, a field “Business Address” 606 may have sub-fields such as “Street,” “City,” “ZIP,” and so forth, corresponding to components of the information that make up a business address.

From the contact information entry form, the user may choose to add a custom, user-defined field. In some embodiments, the interface for creating a user-defined field is a form 700 in a web page. The custom field form 700 includes a box 702 for entering a field name and a menu 706 for selecting a data type. The custom field form 700 may also include a box 704 for entering an optional description of the field to be created. The custom field form 700 may also include one or more additional boxes 708 for entering additional data related to the custom field. The additional box(es) 708 may or may not be present, depending on the data type selected by the user. For example, in FIG. 7, the data type “Multiple Choice” is selected in the data type menu 706. The custom field form 700 includes a box “Choices” 708 for entering the values from which the user may choose for the corresponding field.

User-defined fields that are created may be saved in the database of the marketplace. Furthermore, they may be opened up to other users so that the other users may make use of the user-defined fields when providing or searching for contact information; the user-defined fields are not kept private. In some embodiments, the field name box 702 may include an auto-complete feature that auto-completes whatever string that is typed into the box with names of existing fields. Additionally, in some embodiments, there may be user-created fields that the user-creator may keep private or share with a limited set of users.

Custom, user-defined fields extend the process of providing contact information beyond merely filling a predefined form. Users can add as many fields as needed in order to provide information that is not covered by the predefined fields. The user-defined fields make the information entry process a freeform data entry process that gives users great flexibility in providing various types of information in their possession to the online information marketplace.

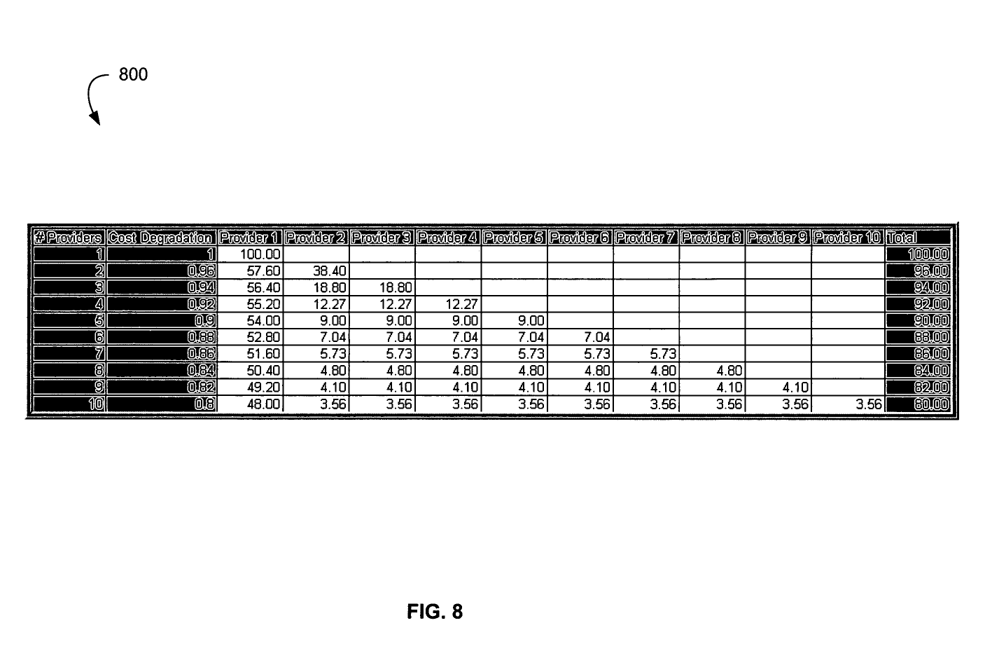

Attention is now directed to FIG. 8, which illustrates an exemplary table of amounts of compensation to one or more information providers in accordance with some embodiments. The table 800 illustrates the amounts of compensation to one or more information sources (labeled as “provider” or “providers” in the table) that provided an item of information (e.g., a contact), which is awarded whenever the item of information is purchased. The amounts are determined in accordance with a compensation formula that is based on the number of information sources that provided the same item of information and which information source provided the item of information first.

As described above, whenever an item of information is purchased, the one or more information sources that provided that item of information are given compensation. In some embodiments, there is one total amount of compensation for an item of information, and that total amount is divided amongst the information sources that provided the item of information. When there is only one information source that has provided the item of information, he gets the full share of the total compensation. As the number of information sources who provided the item of information increases, the source that provided the item of information first gets less than the full share of the total compensation. However, as he is the first to provide the item of information, he gets the largest share.

The remainder of the total compensation is distributed amongst the other information sources that provided the same item of information. In some embodiments, the remainder is divided equally amongst the other information sources. In some other embodiments, the remainder is divided amongst the other information sources such that the order in which the information is provided matters; the second information source to provide the information gets a larger share of the remainder than the third source, the third source gets a larger share than the fourth source, and so on.

As an example of the distribution of the compensation amongst information sources, say that one or more information sources provided the information that a contact named “John Doe” is a golfer, and that total compensation for this item of information (that John Doe is a golfer) is $1 per purchase. If the one or more information sources include only one user, that one user gets $1 for each purchase. If two users had provided this item of information, the user that first entered the item of information into the system gets $0.60 and the other user gets $0.40. If three users had provided this item of information, the user that first entered the item of information into the system gets $0.56 and $0.44 is divided equally amongst the other two users.

In some embodiments, the total amount of compensation for an item of information may degrade as more and more information sources provide the same item of information. As shown in the table 800, the total amount of compensation (rightmost column) decreases as the number of information sources increases. In some other embodiments, there is no degradation; the total amount of compensation is the same regardless of the number of information sources that provided the item of information.

More generally, the amount of compensation for a specified information source for a specific transaction may be expressed as an algorithm or a mathematical formula. In some embodiments, the formula is

C(t,p)=(1−D(N(t)))·P(O(t,p),N(t))·V(t), where:
C(t, p) is the amount of compensation C for a specified information source p for a specified transaction t (e.g., a purchase of an item of information);
D(N(t)) is the degradation factor D, which is based on the number of information sources N(t) who provided the item of information involved in the specified transaction;
P(O(t, p), N(t)) is the order preference factor P, which is based on N(t) and the order O(t, p) in which the information source p provided the item of information involved in the transaction t; and
V(t) is the total value or compensation amount for the transaction t. V(t) may be based on how focused or narrow was the search that yielded the item of information.

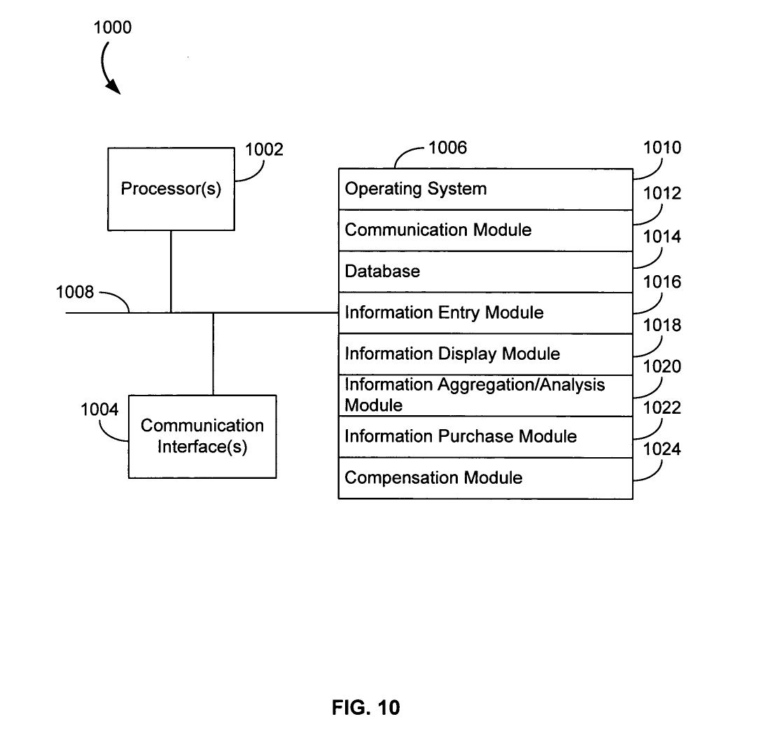

FIG. 10 is a block diagram illustrating an information system 1000 of an online information marketplace in accordance with some embodiments. The information system 1000 typically includes one or more processing units (CPU's) 1002, one or more network or other communications interfaces 1004, memory 1006, and one or more communication buses 1008 for interconnecting these components. The information system 1000 optionally may include a user interface (not shown) comprising a display device and a keyboard. The memory 1006 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 1006 may optionally include one or more storage devices remotely located from the CPU(S) 1002. In some embodiments, the memory 1006 stores the following programs, modules and data structures, or a subset thereof:
an operating system 1010 that includes procedures for handling various basic system services and for performing hardware dependent tasks;
a network communication module 1012 that is used for connecting the information system 1000 to other computers via the one or more communication network interfaces 1004 (wired or wireless), such as the Internet, other wide area networks, local area networks, metropolitan area networks, wireless networks, and so on;
a database 1014 for storing information, such as contact information and user account information;
an information entry module 1016 for receiving information entered by users and storing the received information into the database 1014;
an information display module 1018 for displaying contact information to users in accordance with the provider or purchaser statuses of users;
an information aggregation and analysis module 1020 for aggregating and analyzing contact information in the database 1014;
an information purchase module 1022 for processing user requests to purchase contact information; and
a compensation module 1024 for processing and forwarding compensation to information sources.

Each of the above identified elements may be stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 1006 may store a subset of the modules and data structures identified above. Furthermore, memory 1006 may store additional modules and data structures not described above.

Although FIG. 10 shows an “information system,” FIG. 10 is intended more as functional description of the various features that may be present in a set of servers than as a structural schematic of the embodiments described herein. In practice, and as recognized by those of ordinary skill in the art, items shown separately could be combined and some items could be separated. For example, some items shown separately in FIG. 10 could be implemented on single servers and single items could be implemented by one or more servers. The actual number of servers used to implement an information system and how features are allocated among them will vary from one implementation to another, and may depend in part on the amount of data traffic that the system must handle during peak usage periods as well as during average usage periods.

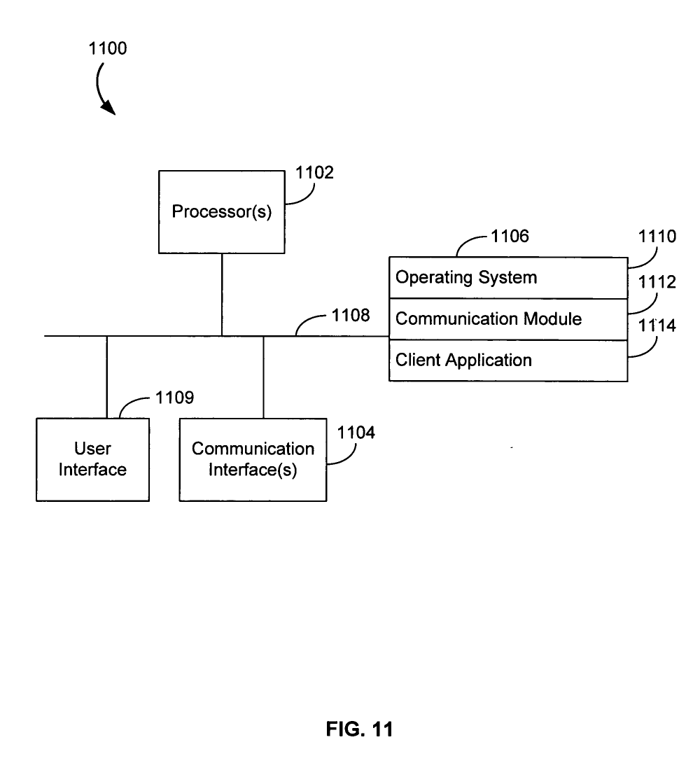

FIG. 11 is a block diagram of a client 1100. The client 1100 generally includes one or more processing units (CPU's) 1102, one or more network or other communications interfaces 1104, memory 1106, and one or more communication buses 1108 for interconnecting these components. The client 1100 also includes a user interface 1109, for instance a display and an input device. Memory 1106 may include high speed random access memory and may also include non-volatile memory, such as one or more magnetic disk storage devices. Memory 1106 may include mass storage that is remotely located from the central processing unit(s) 1102. In some embodiments, the memory 1106 stores the following programs, modules and data structures, or a subset thereof:
an operating system 1110 that includes procedures for handling various basic system services and for performing hardware dependent tasks;
a network communication module 1112 that is used for connecting the information system 1100 to other computers via the one or more communication network interfaces 1104 (wired or wireless), such as the Internet, other wide area networks, local area networks, metropolitan area networks, wireless networks, and so on; and
a client application 1114, such as a web browser, for accessing the online information marketplace.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method, comprising:
receiving information from one or more information sources;
providing at least a subset of the information to a user; and
awarding compensation to one or more respective information sources that provided information included in said subset of the information provided to the user.

2. The method of claim 1, wherein the information comprises contact information.

3. The method of claim 1, wherein the information comprises information provided by the information sources via freeform data entry.

4. The method of claim 3, wherein the information comprises an attribute-value pair comprising an attribute and a value, wherein the attribute is defined by a respective information source.

5. The method of claim 1, wherein the information comprises one or more attribute-value pairs associated with a contact; and
said subset of the information comprises a subset of the attribute-value pairs associated with the contact.

6. The method of claim 1, wherein the information sources are anonymous with respect to the user.

7. The method of claim 1, wherein the user is anonymous with respect to the information sources.

8. The method of claim 1, wherein receiving information comprises receiving information from one or more information sources without solicitation from the user.

9. The method of claim 1, wherein receiving information comprises receiving information from one or more information sources in response to an information request from the user.

10. The method of claim 1, wherein providing at least a subset of the information to a user comprises providing at least a subset of the information to a user in exchange for a payment from the user.

11. The method of claim 1, wherein the amount of the compensation to a respective one of the one or more respective information sources is based at least on a count of the one or more respective information sources who provided said information included in said subset of the information.

12. The method of claim 11, wherein the amount of compensation is further based on a chronological order in which the one or more respective information sources provided said information included in said subset of the information.

13. A computer system, comprising:
memory;
one or more processors; and
one or more modules stored in the memory and configured for execution by the one or more processors, the one or more modules comprising:
instructions to receive information from one or more information sources;
instructions to provide at least a subset of the information to a user; and
instructions to award compensation to one or more respective information sources that provided information included in said subset of the information provided to the user.

14. A computer program product for use in conjunction with a computer system, the computer program product comprising a computer readable storage medium and a computer program mechanism embedded therein, the computer program mechanism comprising:
instructions for receiving information from one or more information sources;
instructions for providing at least a subset of the information to a user; and
instructions for awarding compensation to one or more respective information sources that provided information included in said subset of the information provided to the user.

15. A system, comprising:
means for receiving information from one or more information sources;
means for providing at least a subset of the information to a user; and
means for awarding compensation to one or more respective information sources that provided information included in said subset of the information provided to the user.
